(19) United States
(12) Patent Application Publication
(10) Pub. No.: US 2014/0237346 A1
(43) Pub. Date: Aug. 21, 2014

(54) METHOD AND APPARATUS FOR IMPORTING HYPER TEXT MARKUP LANGUAGE (HTML) WEB PROJECTS INTO A WEB CONTENT MANAGEMENT SYSTEM

(71) Applicant: ADOBE SYSTEMS INC., San Jose, CA (US)

(72) Inventors: Ankur Pathela, New Delhi (IN); Cedric Huesler, Palo Alto, CA (US); Agraj Mangal, New Delhi (IN)

(73) Assignee: ADOBE SYSTEMS INC., San Jose, CA (US)

(21) Appl. No.: 13/771,603

(22) Filed: Feb. 20, 2013

(51) Int. Cl. G06F 17/21

(52) U.S. Cl. CPC G06F 17/218
USPC 715/234

(57) ABSTRACT

A computer implemented method and apparatus for receiving a web project into a web project management tool, wherein the web project comprises web project source code comprising at least one tag, wherein the at least one tag defines at least one component to be editable; parsing the web project source code on the at least one tag to identify the at least one editable component; displaying the web project, wherein the at least one editable component is marked in a user interface to indicate that the component is editable; receiving at least one modification to the at least one editable component; and displaying the web project with the at least one modification.

### BACKGROUND OF THE INVENTION

1. Field of the Invention

Embodiments of the present invention generally relate to webpage design and, more particularly, to a method and apparatus for importing Hyper Text Markup Language (HTML) web projects in a web content management system.

2. Description of the Related Art

The Internet has become a premier place for digital marketers to create immersive social experiences as part of their website to build brand loyalty and generate demand. Web content management systems provide website authoring, collaboration, and administration tools designed to allow marketers with little knowledge of web programming languages or markup languages, such as Hyper Text Markup Language (HTML), to create and manage website content using pre-built page templates. A web page created using HTML comprises tags that define how the elements on a web page look and behave. For example, the tag <font size=“5”> defines a size 5 font. Creation of page templates, however, is a complex activity that requires collaboration between the developers and the marketers. Once a developer exports a web project using a web design tool, the marketer cannot easily edit the project, and is therefore often returned to the developer for editing. In use cases such as Landing Pages, in online marketing, the web page design is an essential cornerstone and needs to be unique for every campaign launched. Every time a new page design needs to be introduced, there are unavoidable workflow steps between the developer and the marketer. The conventional page creation using page templates proves to be time costly and inefficient, and a marketer cannot edit or reuse existing HTML web projects.

Therefore, there is a need for a method and apparatus for importing web projects in a web content management system.

### SUMMARY OF THE INVENTION

A method and apparatus for importing HTML web projects in a web content management system as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram of an apparatus for importing HTML web projects in a web content management system, according to one or more embodiments;

FIG. 2 depicts a flow diagram of a method for importing HTML web projects in a web content management system as performed by the web project manager of FIG. 1, according to one or more embodiments;

FIG. 3 depicts a flow diagram of a method for parsing and displaying a web project as performed by the design importer and the page builder of FIG. 1, according to one or more embodiments;

FIG. 4 depicts a flow diagram of a method for performing edits on an imported web project as performed by the web page editor of FIG. 1, according to one or more embodiments; and

FIG. 5 depicts an illustration of an imported HTML web project, according to one or more embodiments.

While the method and apparatus is described herein by way of example for several embodiments and illustrative drawings, those skilled in the art will recognize that the method and apparatus for importing HTML web projects in a web content management system is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for importing HTML web projects in a web content management system defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Embodiments of the present invention include a method and apparatus for importing HTML web projects in a web content management system. The embodiments receive a web project in the form of an HTML file. The web project may be an archived web project that also includes images, icons, styles sheets, scripts, and the like. In addition to the commonly used tags in the HTML file, the web project includes a plurality of specialized tags. These specialized tags are placed around blocks of HTML code and define editable blocks of the web project. The method imports the web project into the content management system, parses the HTML code, and displays on a screen of a user interface the web project as What-You-See-Is-What-You-Get (WYSIWYG) presentation. Each block of code within the specialized tags may be edited and the results of the edit are displayed. When editing is complete, the web project may be published on the Internet.

Advantageously, the workflow between the marketer and the developer is eliminated. All updates to the HTML web project are performed by the marketer within the web content management system without returning to the developer. This gives the marketer flexibility in finalizing the look and feel of a web project, and saves both time and money while preserving design and animation elements created by the developer. The method may be a plug-in to a web project management tool or the method could be a stand alone editor.

Various embodiments of a method and apparatus for importing HTML web projects in a web content management system are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

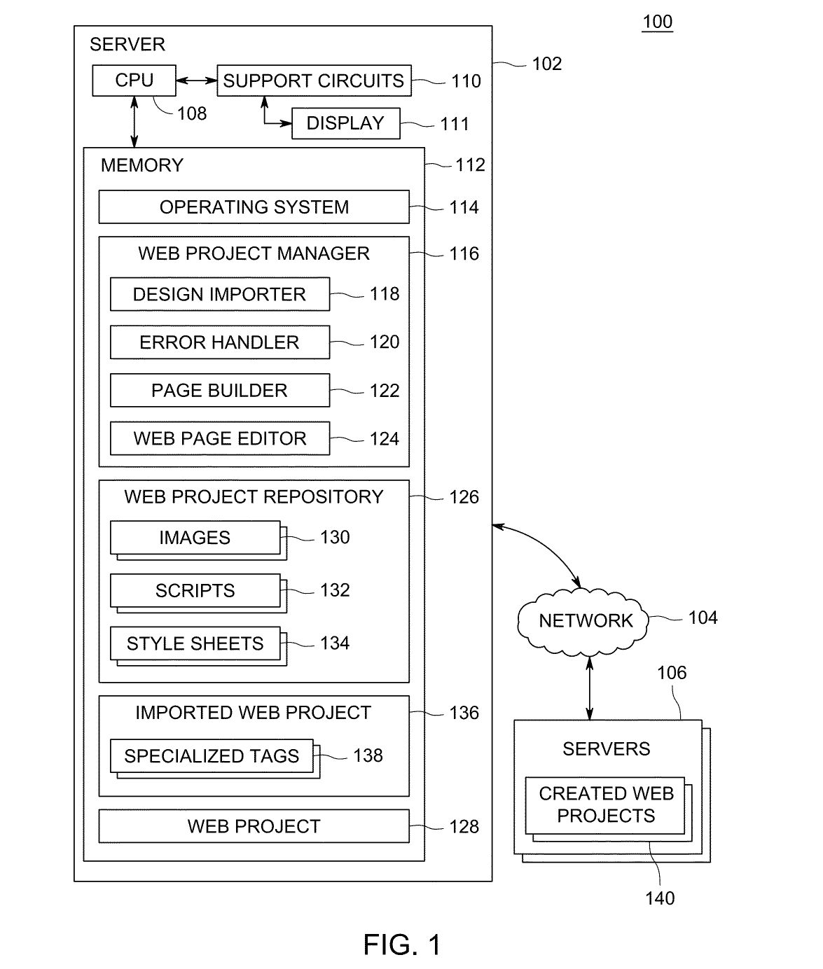

FIG. 1 is a block diagram of an apparatus 100 for importing HTML web projects in a web content management system, according to one or more embodiments. The web content management system may be any web system capable of creating web content, such as ADOBE® CQ, ADOBE® CONTRIBUTE®, and the like. The system 100 includes a server 102, a plurality of web servers 106 communicatively coupled using a network 104. An example of server 102 includes a marketing server, hereinafter referred to as marketing server 102. An example of a web server 106 includes a web developer server, hereinafter referred to as developer web server 106. The marketing server 102 includes a Central Processing Unit (or CPU) 108, support circuits 110, a user interface display 111 and a memory 112. The CPU 108 may include one or more commercially available microprocessors or microcontrollers that facilitate data processing and storage. The various support circuits 110 facilitate the operation of the CPU 108 and include one or more clock circuits, power supplies, cache, input/output circuits, and the like. The memory 112 includes at least one of Read Only Memory (ROM), Random Access Memory (RAM), disk drive storage, optical storage, removable storage and/or the like.

The memory 112 includes an operating system 114, a web project manager 116, a web project repository 126, a web project 128, and an imported web project 136. The operating system 120 may include various commercially known operating systems. The web project manager 116. The web project manager 116 includes a design importer 118, an error handler 120, a page builder 122, and a web page editor 124. The web project repository 126 includes a plurality of images 130, a plurality of scripts 132, and a plurality of style sheets 134. The imported web project 136 includes a plurality of specialized tags 138. The developer servers 106 include a plurality of created web projects 140. The plurality of created web projects 140 may be created using ADOBE® Dreamweaver®, ADOBE® Muse™, or any HTML web design tool.

The web project manager 116 receives a web project 140 from a developer server 106 in the form of an HTML file and stores the web project 140 as an imported web project 136. The imported web project 136 includes specialized tags 138 that define editable blocks of the web project 140. The design importer 118 unloads the imported web project 136 and parses the imported web project 136. The design importer 118 calls the error handler 120 if any problems arise while parsing the imported web project 138. For example, if the syntax is incorrect, such as when a start tag is defined, but a corresponding end tag is missing, the error handler 120 displays an appropriate message that describes the issue. The design importer 118 stores the unloaded web project content in the web project repository 126 in the form of images 130, scripts 132, and style sheets 134.

The page builder 122 receives the parsed web project and creates web page components out of the parsed web project. The components are the blocks of the imported web project 136 that were defined within the specialized tags 138. The page builder 122 calls the error handler 120 if any problems arise while building the web project. For example, if the imported web project 136 includes corrupted content, the error handler 120 displays an appropriate message that describes the issue. If no errors occur, the page builder 122 displays the web project on the display 111. The web page editor 124 accepts edits to the editable components on the display 111, stores the edits, and displays the web project on the display 111 incorporating the newly edited components. When editing is complete, the web project 128 is stored in memory 112 and may be published to the Internet.

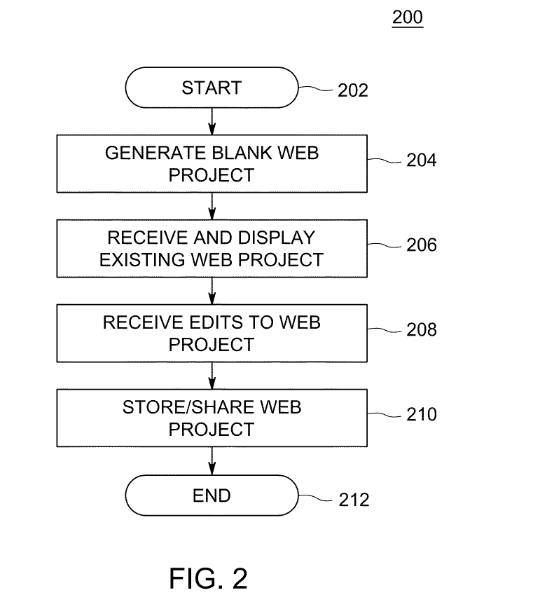

FIG. 2 depicts a flow diagram of a method 200 for importing HTML web projects in a web content management system as performed by the web project manager 116 of FIG. 1, according to one or more embodiments. The method 200 creates a blank project into which a web project is received. The method 200 parses the web project and displays the parsed project with pre-defined editable components. The method 200 receives edits to the editable components and store or publishes the web project when editing is complete.

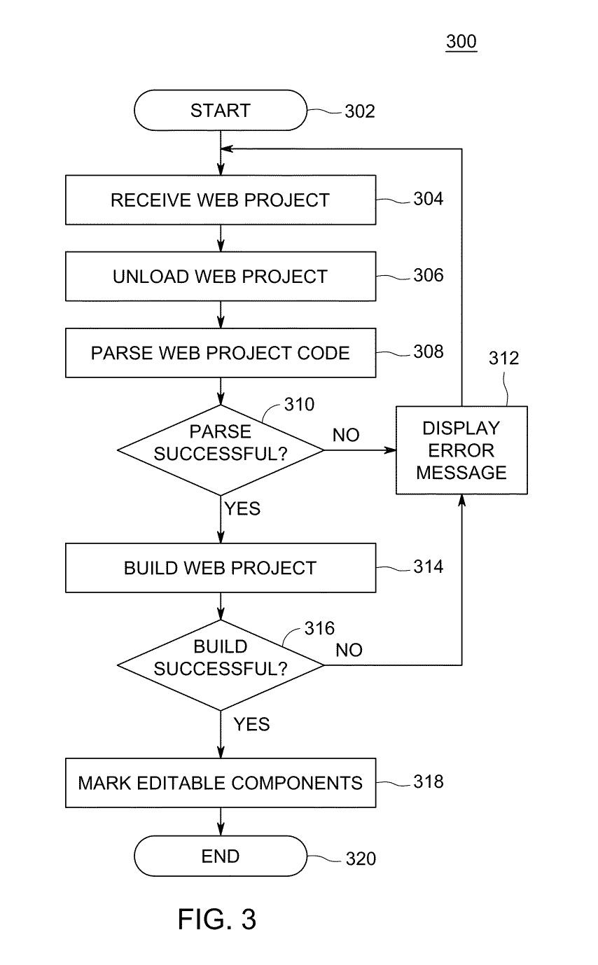

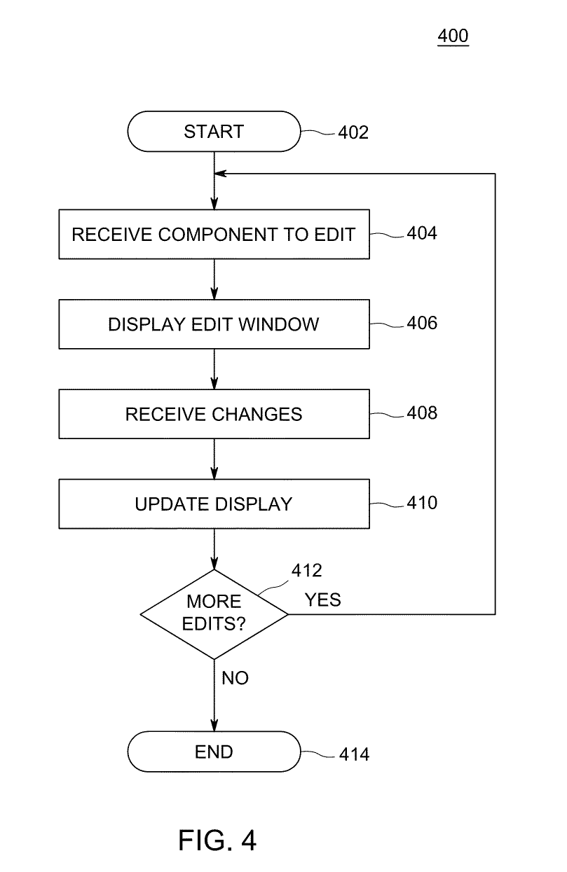

The method 200 starts at step 202 and proceeds to step 204. At step 204, the method 200 opens a blank project into which a web project may be loaded. The method 200 proceeds to step 206, where the method 200 receives a web project, and parses the web project, as described in further detail with respect to FIG. 3 below. The method 200 proceeds to step 208, where the method 200 receives edits to the web project as described in further detail with respect to FIG. 4 below. The method 200 proceeds to step 210, where the method 200 stores and/or publishes the edited web project. The edited web project is stored in memory and may also be published on the Internet. The method 200 proceeds to step 212 and ends.

FIG. 3 depicts a flow diagram of a method 300 for parsing and displaying a web project as performed by the design importer 118 and the page builder 122 of FIG. 1, according to one or more embodiments. The method 300 unloads the elements of a web project file, parses the web project source code, and displays the elements of the web project.

The method 300 starts at step 302 and proceeds to step 304. At step 304, the method 300 receives a web project. The web project may be previously created locally using a web project design tool or the web project may be imported from a web developer. The web project is in the form of an HTML file. The web project includes specialized tags that define editable content within the web project. The method 300 proceeds to step 306, where the method 300 unloads the web page. The method 300 unloads the web project into a web project repository in a pre-defined structure, using any method known in the art. The method 300 stores the images, scripts, and style sheets of the web project in the web project repository for later use by the web page. The method 300 proceeds to step 308, where the method 300 parses the HTML code for the web project. The method 300 identifies tags within the HTML code that define the elements of the web project. The tags may identify text, including the font type and size for the text, one or more images, or other elements of the web project. For example, the web project may contain the following:

<div id=″header″>
<p>Header content</p>
</div>
<img src=″logo.png″>
<img src=″product-image.jpg″>
<p id=”content”> SALE! $99 till the end of this month. Hurry!</p>
<div id=″footer″>
<p>Footer content</p>
</div>

The common HTML tags define elements, such as content for the header, an image in the form of a logo, an image in the form of a product, a sale notification and content for the footer.

Specialized tags are also included. The method 300 identifies the specialized tags that function to define the elements within the specialized tag as editable components of the web project. The value of the specialized tag specifies the type of the output component into which the inner HTML translates. For example, the specialized tag may be <div data-cq-component=“text”> </div>. If a developer wanted the sale notification element to be editable, the web page developer places a specialized tag around the text element as follows:

<div data-cq-component=”text”>
<p id=”content”> SALE! $99 till the end of this month. Hurry!</p>
</div>

If the web page developer chooses to make the title editable, the code may be as follows:

<div data-cq-component=“title”> <h1>Blue Winter Shirt</h1> </div>

If the web page developer chooses to make an image editable, the code may be as follows:

<div data-cq-component=”img”>
<img src=”assets/blue-shirt.png” alt=”Blue Winter Shirt”

width=”200” height=”150”> </div>

The method 300 proceeds to step 310, where the method 300 determines whether the parsing of the HTML code was successful. For example, if an end tag is missing for a corresponding start tag, the HTML code cannot be parsed properly. If the method 300 determines that the parsing was not successful, the method 300 proceeds to step 312, where the method 300 displays an appropriate error message. The method 300 proceeds to step 304, where the method 300 receives a corrected web project.

If at step 310, the parsing is successful, the method 300 proceeds to step 314. At step 314, the method 300 builds the web project and displays the web project on a display. The method 300 displays the parsed elements and editable components on the display as it would appear once published on the Internet. The method 300 proceeds to step 316, where the method 300 determines whether the build was successful. The build is not successful if, for example, content in the web project is corrupted and cannot be displayed in the web project. If the method 300 determines the build was unsuccessful, the method 300 proceeds to step 312, where the method 300 displays an appropriate error message. However, if the build is successful, the method 300 proceeds to step 318. At step 318, the method 300 marks the editable components in any identifiable manner. The method 300 proceeds to step 320 and ends.

FIG. 4 depicts a flow diagram of a method 400 for performing edits on an imported web project as performed by the web page editor 124 of FIG. 1, according to one or more embodiments. The method 400 receives edits to the editable content and updates the web project in the display to reflect the received edits. The method 400 starts at step 402 and proceeds to step 404.

At step 404, the method 400 receives a selection of which component is to be edited. The method 400 proceeds to step 406, where the method 400 allows the component to be edited. In some embodiments, the method 400 displays a popup window including the editable component with appropriate options for modifying the component. For example, if the editable component includes text, the method 400 may display a popup window with an area available to edit the text and selection options typical of a text editor, such as font options, text justification, list options, and the like. If the editable component includes an image, the method 400 may display a popup window within which, for example, an image may be copied, a universal resource locator (URL) for the image may be entered, and the like. In other embodiments, the editable component may be displayed and modified in place using any editing method known in the art.

The method 400 proceeds to step 408 where the method 400 receives the changes to the editable component. In some embodiments, the method 400 receives changes when a button, for example, and “OK” button in a popup window is selected. In other embodiments, the method 400 receives changes when the editable component area is unselected, for example, when a different component is selected. The method 400 proceeds to step 410, where the method 400 updates the display with the edited component. The method 400 updates the display of a user interface showing how the web project will actually look when published. The method 400 proceeds to step 412.

At step 412, the method 400 determines whether editing is complete. In some embodiments, the method 400 determines whether editing is complete when a “SAVE” button is selected or a “PUBLISH” button is selected. In some embodiments, the method 400 determines that editing is complete when the project is closed. If the method 400 determines that editing is not complete, the method 400 proceeds to step 404 and iterates until all editing is complete at which time, the method 400 proceeds to step 414 and ends.

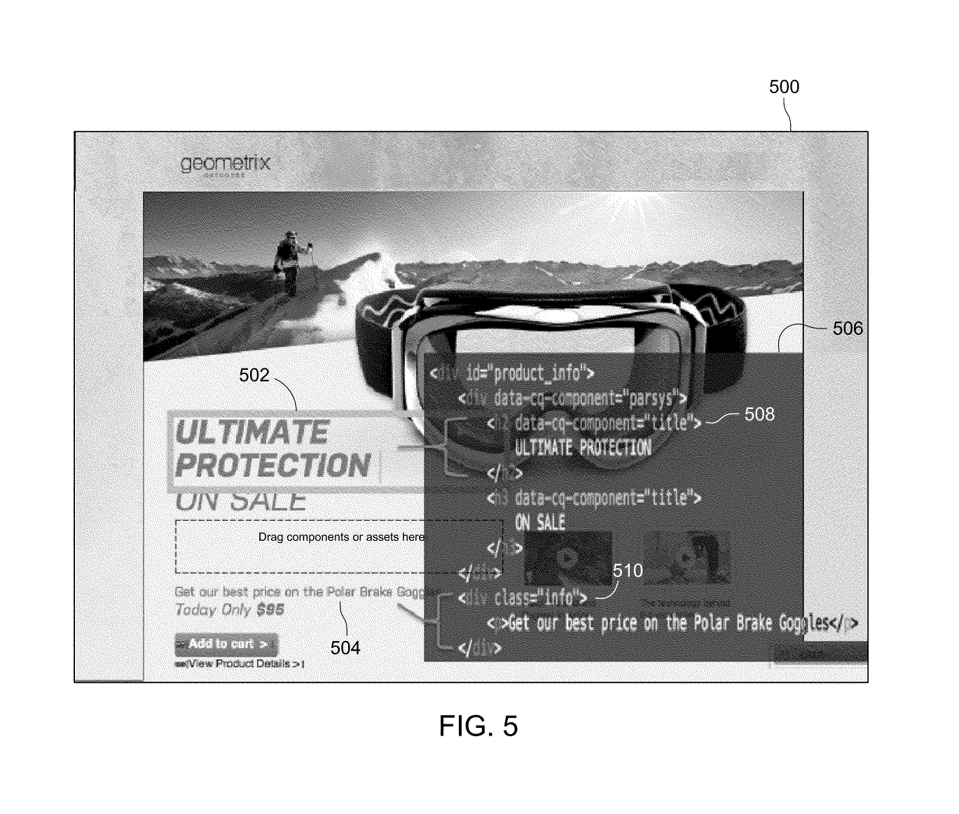

FIG. 5 depicts an illustration of an imported HTML web project 500. The web project comprises a title 502, and a text line 504. Associated with the web project 500 is HTML code 506. The HTML code 506 comprises specialized tags 508, in this example a <data-cq-component> tags and a common HTML tag 510, in this example, a <div> tag. When the HTML web project 500 is imported, the HTML code 506 is parsed. The specialized tag 508 functions to define all of the elements within that specialized tag 508 as editable. In this example, the title “ULTIMATE PROTECTION” and “ON SALE” may be edited. The text line 504 is defined by a common <div> tag. Because the text line 504 does not contain a specialized <data-cq-component> tag in the HTML code 506, the text line 504 may not be edited.

The embodiments of the present invention may be embodied as methods, apparatus, electronic devices, and/or computer program products. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer implemented method comprising:
receiving a web project into a web project management tool, wherein the web project comprises web project source code comprising at least one tag, wherein the at least one tag defines at least one component to be editable;
parsing the web project source code on the at least one tag to identify the at least one editable component;
displaying the web project, wherein the at least one editable component is marked in a user interface to indicate that the component is editable;
receiving at least one modification to the at least one editable component; and
displaying the web project with the at least one modification.

2. The method of claim 1, wherein the web project source code is Hyper Text Markup Language (HTML).

3. The method of claim 1, wherein the received web project is a web project authored remote from the web project management tool so as to comprise the at least one tag.

4. The method of claim 1, wherein parsing converts the web project source code into a what-you-see-is-what-you-get (WYSIWYG) display on the user interface comprising an indication of the at least one editable component.

5. The method of claim 1, wherein the at least one tag comprises a start tag and an end tag, and wherein the web project source code content between the start tag and the end tag of the at least one tag defines the source code content as editable.

6. The method of claim 5, wherein the at least one tag identifies a type of the component into which the web project source code content is translated.

7. An apparatus for enabling import of HTML web projects in a web content management system comprising:
a design importer for receiving a web project into a web project management tool, wherein the web project comprises web project source code comprising at least one tag, wherein the at least one tag defines at least one component to be editable, and parsing the web project source code on the at least one tag to identify the at least one editable component; and
a page builder for creating the web project for display, wherein the at least one editable component is marked in a user interface display to indicate that the component is editable, receiving at least one modification to the at least one editable component, and displaying the web project with the at least one modification.

8. The apparatus of claim 7, further comprising an error handler for displaying an error message when the web project source code cannot be parsed and when the web project components cannot be displayed.

9. The apparatus of claim 7, wherein the web project source code is Hyper Text Markup Language (HTML).

10. The apparatus of claim 7, wherein the received web project is a web project authored remote from the web project management tool so as to comprise the at least one tag.

11. The apparatus of claim 7, wherein parsing converts the web project source code into a what-you-see-is-what-you-get (WYSIWYG) display on the user interface comprising an indication of the at least one editable component.

12. The apparatus of claim 7, wherein the at least one tag comprises a start tag and an end tag, and wherein the web project source code content between the start tag and the end tag of the at least one tag defines the source code content as editable.

13. The apparatus of claim 12, wherein the at least one tag identifies a type of the component the content into which the web project source code content is translated.

14. A non-transient computer readable medium for storing computer instructions that, when executed by at least one processor causes the at least one processor to perform a method for enabling import of HTML web projects in a web content management system comprising:
receiving a web project into a web project management tool, wherein the web project comprises web project source code comprising at least one tag, wherein the at least one tag defines at least one component to be editable;
parsing the web project source code on the at least one tag to identify the at least one editable component;
displaying the web project, wherein the at least one editable component is marked in a user interface to indicate that the component is editable;
receiving at least one modification to the at least one editable component; and
displaying the web project with the at least one modification.

15. The computer readable medium of claim 14, wherein the web project source code is Hyper Text Markup Language (HTML).

16. The computer readable medium of claim 14, wherein the received web project is a web project authored remote from the web project management tool so as to comprise the at least one tag.

17. The computer readable medium of claim 14, wherein parsing converts the web project source code into a what-you-see-is-what-you-get (WYSIWYG) display on the user interface comprising an indication of the at least one editable component.

18. The computer readable medium of claim 14, wherein the at least one tag comprises a start tag and an end tag, and wherein the web project source code content between the start tag and the end tag of the at least one tag defines the source code content as editable.

19. The computer readable medium of claim 18, wherein the at least one tag identifies a type of the component the content into which the web project source code content is translated.
